(19) United States
(12) Patent Application Publication
(10) Pub. No.: US 2009/0117985 A1
(43) Pub. Date: May 7, 2009

(54) GAMING SYSTEM AND A METHOD OF GAMING

(75) Inventor: Michael Allan Shai-Hee, Kingsgrove (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, Lane Cove (AU)

(21) Appl. No.: 12/247,809

(22) Filed: Oct. 8, 2008

(30) Foreign Application Priority Data
Oct. 8, 2007 (AU) 2007905487

(51) Int. Cl. A63F 9/24; A63F 13/00

(52) U.S. Cl. 463/20

(57) ABSTRACT

A gaming system comprising: a display; a memory storing reel data defining a plurality of reels, each reel comprising a set of symbols in a symbol sequence; and a game controller arranged to: select symbols from the reel data for display at a plurality of display positions, the selection of at least two symbols of at least one reel being performed independently of the symbol sequence; display the selected symbols at respective separate display positions on the display; and control display of spinning of the reels on the display such that for each reel for which symbols are selected independently of the symbol sequence: after the reel is stopped, the at least two selected symbols of each reel are displayed in their respective display positions; and during at least part of the display of spinning, the reel is displayed as spinning in the symbol sequence relative to the display positions.

### CROSS-REFERENCE TO RELATED APPLICATIONS

The present application claims the benefit of priority to Australian Provisional Patent Application No. 2007905487, filed on Oct. 8, 2007, entitled “A GAMING SYSTEM AND A METHOD OF GAMING”, which is herein incorporated by reference in its entirety.

### FIELD

The present invention relates to a gaming system, a method of gaming, a game controller and computer program code.

### BACKGROUND TO THE INVENTION

It is known to provide a gaming system such as a video slot machine wherein symbols are displayed as a plurality of virtual reels on a video display. Each reel comprises a plurality of symbols arranged in a predetermined sequence. Typically, when a reel stops, a plurality of symbols of each reel are visible on the display. For example, three symbols of each reel. While the stopping position of the reel can be chosen in a number of different ways, in all cases, the symbols which stop in the display are adjoining symbols in the symbol sequence. Typically, when spinning of the reels is simulated, symbols before the stopped symbols in the symbol sequence will be visible at least as the reel comes to a stop.

While such gaming systems provide users with enjoyment, a need exists for alternative gaming systems in order to maintain or increase player enjoyment.

### SUMMARY OF THE INVENTION

In a first aspect the invention provides a gaming system including:
a display;
a memory storing reel data defining a plurality of reels, each reel including a set of symbols in a symbol sequence; and
a game controller arranged to:
   select symbols from the reel data for display at a plurality of display positions, the selection of at least two symbols of at least one reel being performed independently of the symbol sequence;
   display the selected symbols at respective separate display positions on the display; and
   control display of spinning of the reels on the display such that for each reel for which symbols are selected independently of the symbol sequence:
      after the reel is stopped, the at least two selected symbols of each reel are displayed in their respective display positions; and
      during at least part of the display of spinning, the reel is displayed as spinning in the symbol sequence relative to the display positions.

In an embodiment, the game controller is arranged to determine a stopping order for the at least two symbols.

In an embodiment, the game controller is arranged to display a first symbol of the at least two symbols as stopping at the symbol's display position and subsequently display a corresponding reel as continuing to spin in the symbol sequence.

In an embodiment, a corresponding reel is displayed as continuing to spin in the symbol sequence until all of the at least two symbols have been displayed as stopping in their respective positions.

In an embodiment, a corresponding reel is displayed as spinning behind any stopped symbols such that the symbols of a corresponding reel are not visible as they pass each stopped symbol.

In an embodiment, three symbols are selected for each reel for display at respective ones of three display positions.

In an embodiment, there are five reels.

In an embodiment, the game controller includes a display controller for controlling the display.

In an embodiment, the game controller includes a symbol selector for selecting the symbols.

In a second aspect the invention provides a game controller arranged to:
select symbols for display at a plurality of display positions from reel data defining a plurality of reels, each reel including a set of symbols in a symbol sequence and the selection of at least two symbols of at least one reel being performed independently of the symbol sequence;
cause a display to display the selected symbols at respective separate display positions on the display; and
control display of spinning of the reels on the display such that for each reel for which symbols are selected independently of the symbol sequence:
   after the reel is stopped, the at least two selected symbols of each reel are displayed in their respective display positions; and
   during at least part of the display of spinning, the reel is displayed as spinning in the symbol sequence relative to the display positions.

In an embodiment, the game controller is arranged to determine a stopping order for the at least two symbols.

In an embodiment, the game controller is arranged to display a first symbol of the at least two symbols as stopping at the symbol's display position and subsequently display a corresponding reel as continuing to spin in the symbol sequence.

In an embodiment, a corresponding reel is displayed as continuing to spin in the symbol sequence until all of the at least two symbols have been displayed as stopping in their respective positions.

In an embodiment, a corresponding reel is displayed as spinning behind any stopped symbols such that the symbols of a corresponding reel are not visible as they pass each stopped symbol.

In an embodiment, three symbols are selected for each reel for display at respective ones of three display positions.

In an embodiment, there are five reels.

In an embodiment, the game controller includes a display controller for controlling the display.

In an embodiment, the game controller includes a symbol selector for selecting the symbols.

In an embodiment, the game controller is constituted, at least in part, by a processor executing program code stored in a memory.

In a third aspect the invention provides a method of gaming including:
selecting symbols for each of a plurality of reels each for display at a plurality of display positions, each reel defined by a set of symbols in a symbol sequence, the selection of at least two symbols for at least one of a plurality of reels being made independently of the symbol sequence;
displaying the selected symbols at separate respective display positions on a display for each reel; and
controlling display of spinning of the reels on the display such that for each reel for which symbols are selected independently of the symbol sequence:
   after the reel is stopped, the at least two selected symbols of each reel are displayed in their respective display positions; and
   during at least part of the display of spinning, the reel is displayed as spinning in the symbol sequence relative to the display positions.

In an embodiment, the method includes determining a stopping order for the at least two symbols.

In an embodiment, the method includes displaying a first symbol of the at least two symbols as stopping at the symbol's display position and subsequently displaying a corresponding reel as continuing to spin in the symbol sequence.

In an embodiment, a corresponding reel is displayed as continuing to spin in the symbol sequence until all of the at least two symbols have been displayed as stopping in their respective positions.

In an embodiment, a corresponding reel is displayed as spinning behind any stopped symbols such that the symbols of each corresponding reel are not visible as they pass each stopped symbol.

In a fourth aspect the invention provides a gaming system including:
a display;
a memory storing reel data defining a plurality of reels, each reel including a set of symbols in a symbol sequence; and
a game controller arranged to:
   select symbols from the reel data for display at a plurality of display positions, the selection of at least one symbol of at least one reel to stop being performed independently of the symbol sequence;
   display each selected symbol at a display position; and
   control display of spinning of the reels on the display of each reel for which at least one symbol is selected independently of the symbol sequence such that after at least one selected symbol is displayed as stopped at its display position, the remainder of the reel is displayed as spinning in the symbol sequence relative to the stopped symbol.

In an embodiment, the game controller is arranged to select at least two symbols and to determine a stopping order for the at least two symbols.

In an embodiment, a corresponding reel is displayed as continuing to spin in the symbol sequence until all of the at least one symbols have been displayed as stopping in their respective positions.

In an embodiment, a corresponding reel is displayed as spinning behind any stopped symbols such that the symbols of a corresponding reel are not visible as they pass each stopped symbol.

In an embodiment, three symbols are selected for each reel for display at respective ones of three display positions.

In an embodiment, there are five reels.

In an embodiment, the game controller includes a display controller for controlling the display.

In an embodiment, the gaming system includes a symbol selector for selecting the symbols.

In a fifth aspect the invention provides a game controller arranged to:
select symbols from reel data defining a plurality of reels for display at a plurality of display positions, each reel including a set of symbols in a symbol sequence, the selection of at least one symbol of at least one reel to stop being performed independently of the symbol sequence;
   display each selected symbol at a display position; and
   control display of spinning of the reels on the display of each reel for which at least one symbol is selected independently of the symbol sequence such that after at least one selected symbol is displayed as stopped at its display position, the remainder of the reel is displayed as spinning in the symbol sequence relative to the stopped symbol.

In an embodiment, the game controller is arranged to select at least two symbols and to determine a stopping order for the at least two symbols.

In an embodiment, a corresponding reel is displayed as continuing to spin in the symbol sequence until all of the at least one symbols have been displayed as stopping in their respective positions.

In an embodiment, a corresponding reel is displayed as spinning behind any stopped symbols such that the symbols of a corresponding reel are not visible as they pass each stopped symbol.

In an embodiment, three symbols are selected for each reel for display at respective ones of three display positions.

In an embodiment, there are five reels.

In an embodiment, the game controller includes a display controller for controlling the display.

In an embodiment, the game controller includes a symbol selector for selecting the symbols.

In an embodiment, is constituted, at least in part, by a processor executing program code stored in a memory.

In a sixth aspect the invention provides a method of gaming including:
selecting at least one symbol of at least one reel of a plurality of reels to stop independently of the symbol sequence, each reel including a set of symbols in a symbol sequence, the selection being made independently of the symbol sequence;
causing a display to display each selected symbol at a display position; and
controlling display of spinning of the reels on the display such that for each reel for which at least one symbol is selected independently of the symbol sequence such that after at least one selected symbol is displayed as stopped at its display position, the remainder of the reel is displayed as spinning in the symbol sequence relative to the stopped symbol.

In an embodiment, the method includes selecting at least two symbols and to determine a stopping order for the at least two symbols.

In an embodiment, the method includes displaying a corresponding reel as continuing to spin in the symbol sequence until all of the at least one symbols have been displayed as stopping in their respective positions.

In an embodiment, a corresponding reel is displayed as spinning behind any stopped symbols such that the symbols of a corresponding reel are not visible as they pass each stopped symbol.

In a seventh aspect, the invention provides computer program code which when executed implements the above methods.

In an eighth aspect, the invention provides a computer readable storage medium including the program code.

In a ninth aspect, the invention provides a data signal including the program code.

In a tenth aspect, the invention extends to transmitting program code.

### BRIEF DESCRIPTION OF THE DRAWINGS

Certain embodiments of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a diagram schematic of a networked gaming system;

FIG. 6 is a further block diagram of the gaming system;

FIG. 7 is a flowchart of an embodiment;

FIG. 8 shows how symbols may be held while a reel continues to spin; and

FIG. 9 shows an exemplary outcome for one reel.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

An embodiment provides a gaming system of the type that implements a spinning reel game where there are a plurality of reels having a plurality of symbols in a designated symbol sequence. The gaming system has a game controller which implements a game where one or more symbols are selected independently of the symbol sequence for display whereby the displayed symbols of each reel may be non-adjacent symbols. The display of spinning of the reels is controlled such that during at least part of the display of spinning, the reel is displayed as spinning in the symbol sequence relative to the display positions. In an embodiment, this is achieved by displaying each selected symbol as stopping independently while the remainder of the reel is displayed as continuing to rotate. In one embodiment, symbols are selected for each reel independently of the symbol sequence. In other embodiments, symbols may be selected independently for a subset of reels.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

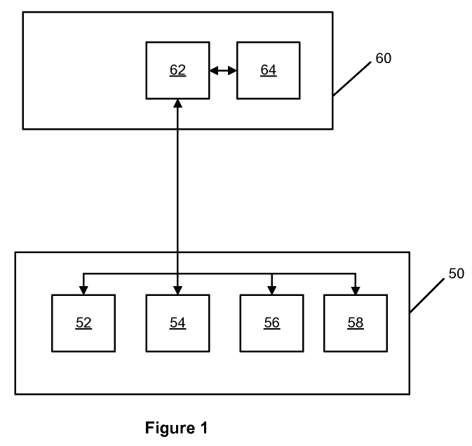

Irrespective of the form, the gaming system includes several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54, a game play mechanism 56 that enables a player to input game play instructions, and a speaker 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

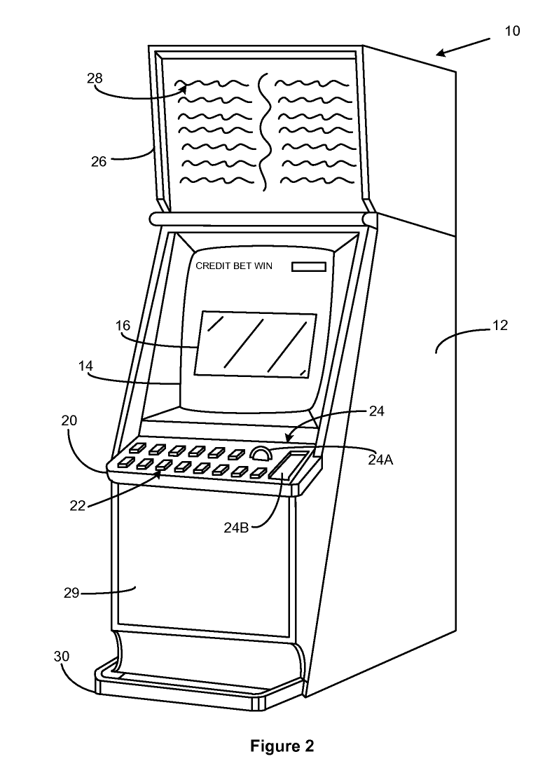

A gaming system in the form of a stand alone gaming machine 10 is illustrated in FIG. 2. The gaming machine 10 includes a console 12 having a video display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module may be provided having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit. The top box 26 may also include a display, for example a video display unit, which may be of the same type as the display 14, or of a different type.

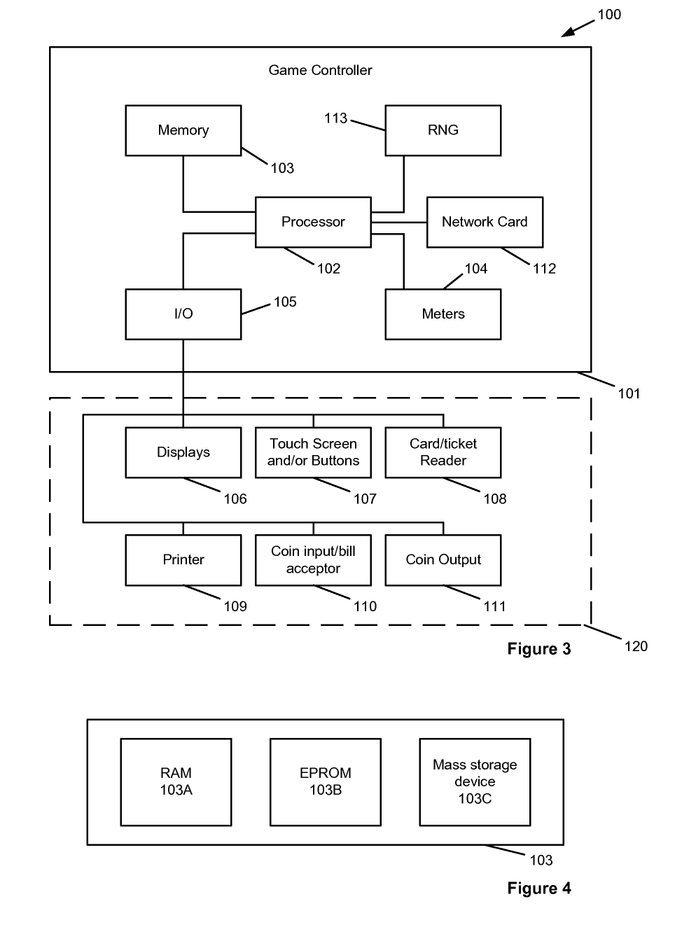

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted depending on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

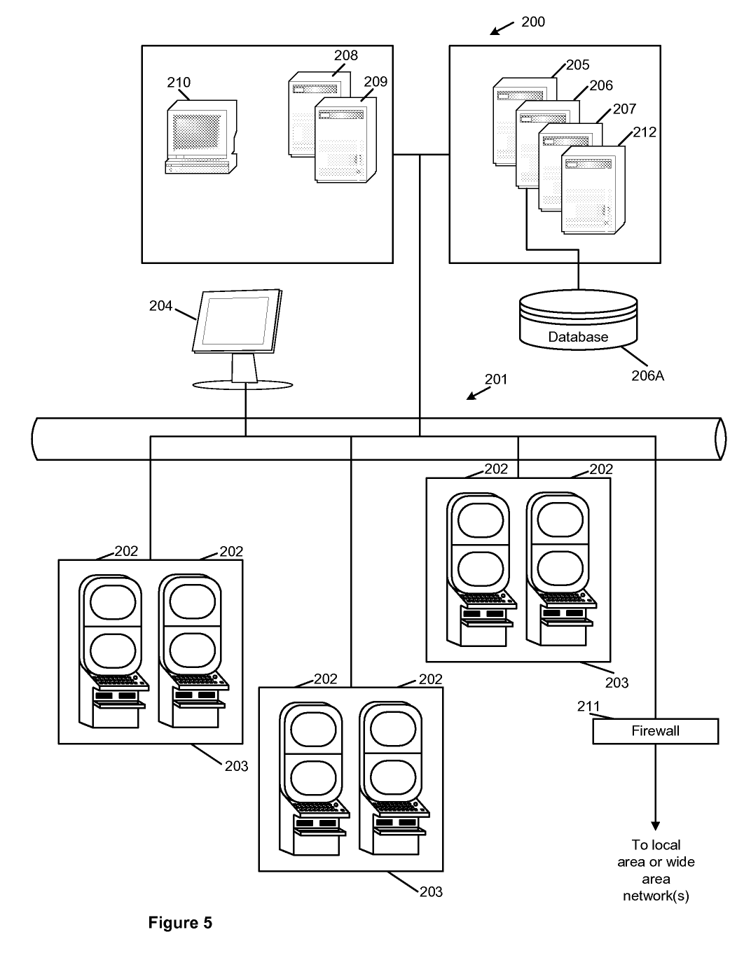

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to carry out the accounting in respect of the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games based on the terminals.

An embodiment provides a spinning reel type game. Spinning reel type games typically allow a player to select how many win lines of a plurality of win lines they will play in each game—i.e. a minimum of one win line up to the maximum number of win lines allowed by the game. Persons, skilled in the art, will appreciate that in other embodiments, the player may select a number of reels to play. In most games, each win line is formed by a set of symbol positions consisting of one symbol position from each reel. That is, a symbol position within the display which corresponds to a reel is assigned to a win line. The symbol positions that constitute each of the win lines are usually advertised to the player by markings on the display or diagrams showing the symbol positions that correspond to each win line. Some of the win lines will be horizontal or diagonal lines but others may be other combinations of symbols. Typically, the win lines will be constituted by symbol positions in the visible window. A game outcome is determined based on the symbols on the win lines and a prize table that specifies awards. Many modern games have five reels and three symbols of each reel are displayed when the reels stop.

In prior art implementations, the game controllers of such gaming machines select symbols by employing a stop determining function that randomly determines the stop position for each reel. For example, if there are five reels, each having twenty symbols in a designated symbol, the stop determining function might determine that the stop positions are positions: 3, 13, 7, 9 and 17. The spinning of the reels is then controlled so that each symbol designated by the stop position comes to a stop in the same row, typically a predetermined row in a “window” visible to the player on the display that corresponds to a player playing a single win line—e.g. the middle row. The other symbols that are visible in the display will be adjacent symbols in the symbol sequence—e.g. if the determined stop position is 3, then the symbols allocated to positions 2 and 4 will also be visible if three symbols of each reel are displayed.

The gaming system of an embodiment departs from the prior art by selecting at least one of the symbols independently of the symbol sequence while still displaying the symbols as virtual reels that spin in the symbol sequence.

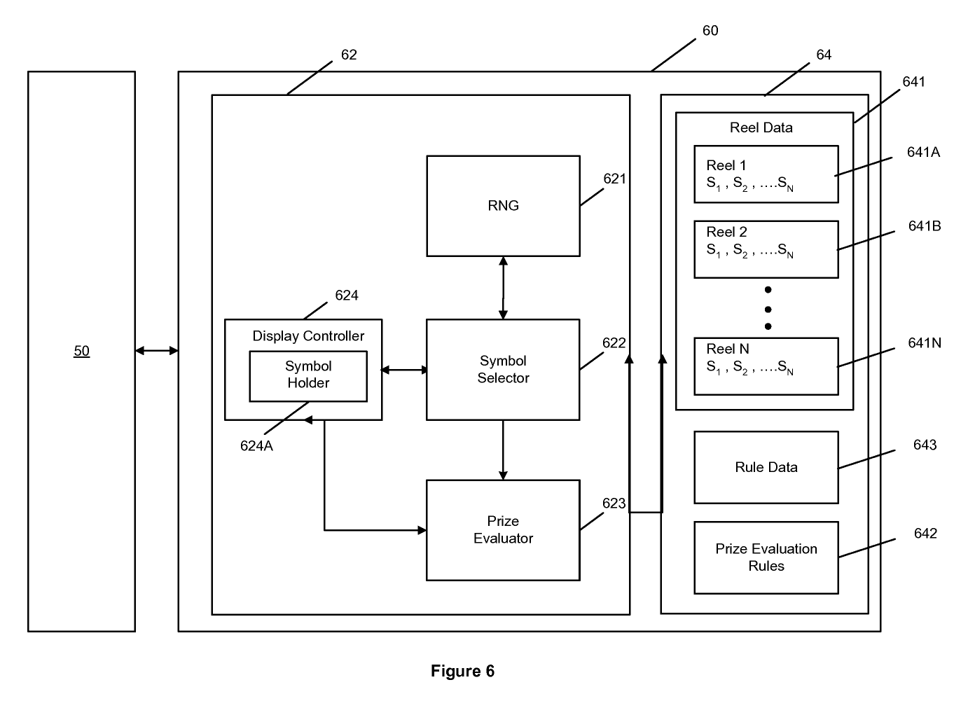

The game controller 60 of the embodiment is shown in more detail in FIG. 6. It will be apparent that the processor 62 implements a number of modules, for example random number generator module 621 by executing software routines. Persons skilled in the art will appreciate that not all modules need be implemented by processor 62. For example, the random number generator module 621 could be implemented by a separate circuit or by a random number generator server.

Referring to FIG. 6, in the embodiment, the symbol selector 622 is arranged to select a plurality of symbols for each reel independently of the symbol order S₁ to S_{N} specified in the reel data of each reel, reel 1 to reel N 641a, 641b, 641n.

The symbol selector 622 sends data which indicates the order in which the symbols of each reel were selected to the display controller 624.

The display controller 624 controls display of spinning and stopping of the symbols of each reel such that the three symbols stop in their display positions independently of one another. Accordingly it includes a symbol holder function 624a which is arranged to control the display 54 so that display of stopped symbols is maintained while the remainder of the reel is display as spinning until all the selected symbols stop. The symbol holder function 624a is also arranged to adjust the display of the reels such that on subsequent rotations of the reels symbols which were previously either side of a stopped symbol in the symbol sequence are shown as adjacent. In this manner, non-adjacent symbols in the symbols set may be stopped in adjacent display positions on the display. That is, the symbols are displayed in a sequence, for example from S₁ to S_{Nm}, and then continues from S₁.

It will be appreciated that the technique has application provided for at least one reel, the reel can continue spin in the symbol sequence after at least one symbol has been stopped. In one embodiment, a subset of one or more of the reels may have symbols that are selected independently of the stop sequence. In one embodiment, a subset of one or more of the symbols of each reel may be selected independently of the sequence. For example, if there are three display positions for each reel, the top position could be selected independently of the sequence for each reel. The reels would then be spun and the top symbol of each reel stopped while the remainder of the reel continues to spin with the remaining symbols coming to a stop in the symbol sequence.

In a typical implementation, there will be five reels and three display positions for each reel as indicated by the 5×3 matrix of display positions 810 in FIG. 8. Accordingly, in an example where a reel contains symbols from S₁ to S₃₀, i.e. S₁ is the first symbol position, S₃₀ is the last and any other symbol in between such as S₁₀ represents the 10^{th} position in that reel. This reel is to spin within a reel column size of three symbols.

Let the following symbols be defined as:

### S₈=TEN [10]

### S₉=ACE [A]

### S₁₀=JACK [J]

### S₁₅=QUEEN [Q]

### S₂₁=KING [K]

As the reel spin moves down, symbol S₉ [ACE] 830 stops at the middle reel position as shown in FIG. 8.

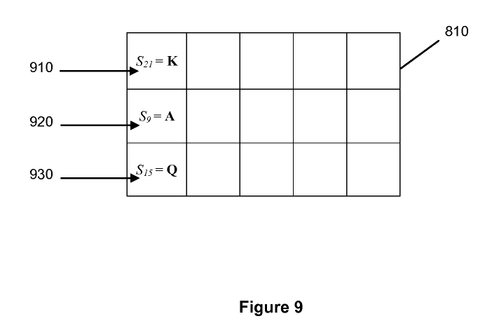

The grid 810 defines the reel stop positions. The ACE symbol stops 830 on the middle reel stop position but the symbols TEN 840 and JACK 850 continue to move along with the reel spin as shown by their partial visibility. The TEN symbol 840 moves behind the ACE and the JACK 850 moves outside the reel column boundary. The shaded area 860 is where the ACE symbol used to be positioned on that reel but is now blank as the ACE is “stuck” onto the middle stop reel position. This blank position may be removed from sight when the reel spins on subsequent revolutions i.e. S₈ will follow S₁₀ on subsequent spinning. As the reel continues to spin, the symbol S₂₁ [KING] 910 stops at the top reel position and will visually operate in the same way as was done for the ACE 820 symbol—i.e. the reel will continue to spin. Finally, symbol S₁₅ [QUEEN] 930 stops at the bottom reel position. The reel column will then appear as KING, ACE, QUEEN as shown in FIG. 9.

Thus, symbols displayed on the reel column do not follow the symbol order on the original reel.

After the symbols have all stopped as indicated in FIG. 9, the prize is evaluated by the prize evaluator 623 based on the prize evaluation rules. The prize outcomes will depend on the symbol combinations that appear on win lines.

It will be appreciated in the above example the game controller determines the stopping order of the symbols by the order in which they are selected. In other embodiments, the symbol selector may be arranged to select symbols for particular positions and the game rules may specify the stopping positions assigned to those display positions.

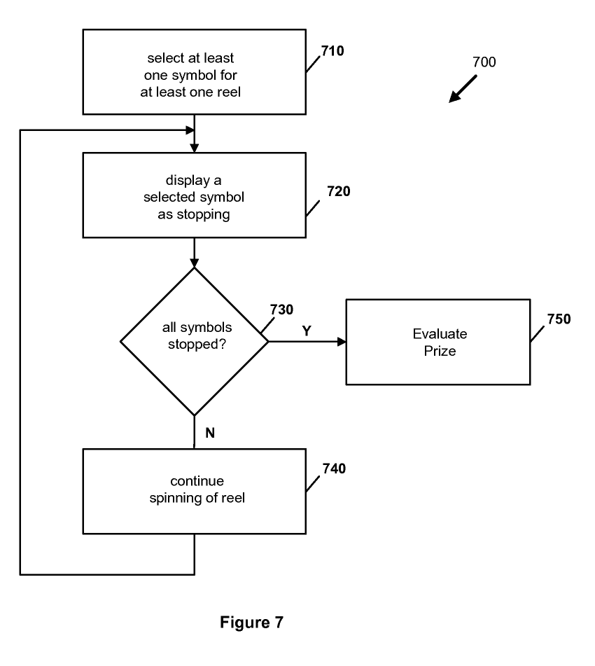

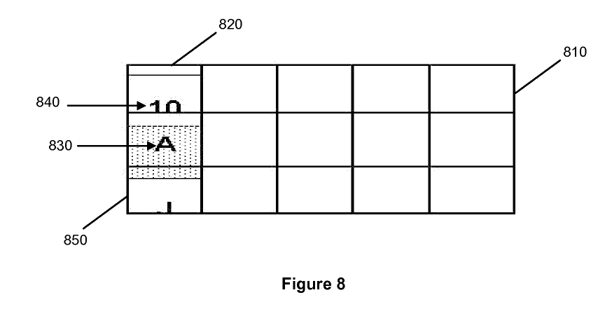

The method 700 is summarised in FIG. 7 which shows that at least one symbol is selected for at least one reel 710 to stop independently of the symbol sequence. Depending on the embodiment, the display position and reel may also be selected. A selected symbol is then displayed as stopping at a display position 720. It is then determined whether all symbols have been stopped 730 such that at least on the initial spin, spinning of the reel continues 740. The process continues until all symbols have been displayed as stopped after which time a prize is awarded 750.

Persons skilled in the art will appreciate that a number of variations may be made to the above method including that the symbols on each of the reels may be stopped independently of one another or the reels may stop one at a time. Further, one symbol of each reel may be stopped and then a subsequent symbol of each reel stopped.

Other variations would be apparent to persons skilled in the art and should be considered as falling within the scope of the invention described herein. In particular, further embodiments can be formed from the features described above.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory 103) or as a data signal (for example, by downloading it from a server).

It is to be understood that, if any prior art publication is referred to herein, such reference does not constitute an admission that the publication forms a part of the common general knowledge in the art, in Australia or any other country.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Method steps associated with certain embodiments may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A gaming system comprising:
a display;
a memory storing reel data defining a plurality of reels, each reel comprising a set of symbols in a symbol sequence; and
a game controller arranged to:
select symbols from the reel data for display at a plurality of display positions, the selection of at least two symbols of at least one reel being performed independently of the symbol sequence;
display the selected symbols at respective separate display positions on the display; and
control display of spinning of the reels on the display such that for each reel for which symbols are selected independently of the symbol sequence:
after the reel is stopped, the at least two selected symbols of each reel are displayed in their respective display positions; and
during at least part of the display of spinning, the reel is displayed as spinning in the symbol sequence relative to the display positions.

2. A gaming system as claimed in claim 1, wherein the game controller is arranged to determine a stopping order for the at least two symbols.

3. A gaming system as claimed in claim 1, wherein the game controller is arranged to display a first symbol of the at least two symbols as stopping at the symbol's display position and subsequently display a corresponding reel as continuing to spin in the symbol sequence.

4. A gaming system as claimed in claim 3, wherein a corresponding reel is displayed as continuing to spin in the symbol sequence until all of the at least two symbols have been displayed as stopping in their respective positions.

5. A gaming system as claimed in claim 3, wherein a corresponding reel is displayed as spinning behind any stopped symbols such that the symbols of a corresponding reel are not visible as they pass each stopped symbol.

6. A gaming system as claimed in claim 1, wherein three symbols are selected for each reel for display at respective ones of three display positions.

7. A gaming system as claimed in claim 1, wherein there are five reels.

8. A gaming system as claimed in claim 1, wherein the game controller comprises a display controller for controlling the display.

9. A gaming system as claimed in claim 1, the game controller comprises a symbol selector for selecting the symbols.

10. A game controller arranged to:
select symbols for display at a plurality of display positions from reel data defining a plurality of reels, each reel comprising a set of symbols in a symbol sequence and the selection of at least two symbols of at least one reel being performed independently of the symbol sequence;
cause a display to display the selected symbols at respective separate display positions on the display; and
control display of spinning of the reels on the display such that for each reel for which symbols are selected independently of the symbol sequence:
after the reel is stopped, the at least two selected symbols of each reel are displayed in their respective display positions; and
during at least part of the display of spinning, the reel is displayed as spinning in the symbol sequence relative to the display positions.

11. A game controller as claimed in claim 10, arranged to determine a stopping order for the at least two symbols.

12. A game controller as claimed in claim 10, arranged to display a first symbol of the at least two symbols as stopping at the symbol's display position and subsequently display a corresponding reel as continuing to spin in the symbol sequence.

13. A game controller as claimed in claim 12, wherein corresponding reel is displayed as continuing to spin in the symbol sequence until all of the at least two symbols have been displayed as stopping in their respective positions.

14. A game controller as claimed in claim 12, wherein a corresponding reel is displayed as spinning behind any stopped symbols such that the symbols of a corresponding reel are not visible as they pass each stopped symbol.

15. A game controller as claimed in claim 10, wherein three symbols are selected for each reel for display at respective ones of three display positions.

16. A game controller as claimed in claim 10, wherein there are five reels.

17. A game controller as claimed in claim 10, wherein the game controller comprises a display controller for controlling the display.

18. A game controller as claimed in claim 10, comprising a symbol selector for selecting the symbols.

19. A game controller as claimed in claim 10, constituted, at least in part, by a processor executing program code stored in a memory.

20. A method of gaming comprising:
selecting symbols for each of a plurality of reels each for display at a plurality of display positions, each reel defined by a set of symbols in a symbol sequence, the selection of at least two symbols for at least one of a plurality of reels being made independently of the symbol sequence;
displaying the selected symbols at separate respective display positions on a display for each reel; and
controlling display of spinning of the reels on the display such that for each reel for which symbols are selected independently of the symbol sequence:
after the reel is stopped, the at least two selected symbols of each reel are displayed in their respective display positions; and
during at least part of the display of spinning, the reel is displayed as spinning in the symbol sequence relative to the display positions.

21. A method as claimed in claim 20, comprising determining a stopping order for the at least two symbols.

22. A method as claimed in claim 20, comprising displaying a first symbol of the at least two symbols as stopping at the symbol's display position and subsequently displaying a corresponding reel as continuing to spin in the symbol sequence.

23. A gaming system as claimed in claim 22, wherein a corresponding reel is displayed as continuing to spin in the symbol sequence until all of the at least two symbols have been displayed as stopping in their respective positions.

24. A gaming system as claimed in claim 22, wherein a corresponding reel is displayed as spinning behind any stopped symbols such that the symbols of each corresponding reel are not visible as they pass each stopped symbol.

25. A gaming system comprising:
a display;
a memory storing reel data defining a plurality of reels, each reel comprising a set of symbols in a symbol sequence; and
a game controller arranged to:
select symbols from the reel data for display at a plurality of display positions, the selection of at least one symbol of at least one reel to stop being performed independently of the symbol sequence;
display each selected symbol at a display position; and
control display of spinning of the reels on the display of each reel for which at least one symbol is selected independently of the symbol sequence such that after at least one selected symbol is displayed as stopped at its display position, the remainder of the reel is displayed as spinning in the symbol sequence relative to the stopped symbol.

26. A gaming system as claimed in claim 25, wherein the game controller is arranged to select at least two symbols and to determine a stopping order for the at least two symbols.

27. A gaming system as claimed in claim 25, wherein a corresponding reel is displayed as continuing to spin in the symbol sequence until all of the at least one symbols have been displayed as stopping in their respective positions.

28. A gaming system as claimed in claim 25, wherein a corresponding reel is displayed as spinning behind any stopped symbols such that the symbols of a corresponding reel are not visible as they pass each stopped symbol.

29. A gaming system as claimed in claim 25, wherein three symbols are selected for each reel for display at respective ones of three display positions.

30. A gaming system as claimed in claim 25, wherein there are five reels.

31. A gaming system as claimed in claim 25, wherein the game controller comprises a display controller for controlling the display.

32. A gaming system as claimed in claim 25, comprising a symbol selector for selecting the symbols.

33. A game controller arranged to:
select symbols from reel data defining a plurality of reels for display at a plurality of display positions, each reel comprising a set of symbols in a symbol sequence, the selection of at least one symbol of at least one reel to stop being performed independently of the symbol sequence;
display each selected symbol at a display position; and
control display of spinning of the reels on the display of each reel for which at least one symbol is selected independently of the symbol sequence such that after at least one selected symbol is displayed as stopped at its display position, the remainder of the reel is displayed as spinning in the symbol sequence relative to the stopped symbol.

34. A game controller as claimed in claim 33, arranged to select at least two symbols and to determine a stopping order for the at least two symbols.

35. A game controller as claimed in claim 33, wherein a corresponding reel is displayed as continuing to spin in the symbol sequence until all of the at least one symbols have been displayed as stopping in their respective positions.

36. A game controller as claimed in claim 33, wherein a corresponding reel is displayed as spinning behind any stopped symbols such that the symbols of a corresponding reel are not visible as they pass each stopped symbol.

37. A game controller as claimed in claim 33, wherein three symbols are selected for each reel for display at respective ones of three display positions.

38. A game controller as claimed in claim 33, wherein there are five reels.

39. A game controller as claimed in claim 33, comprising a display controller for controlling the display.

40. A game controller as claimed in claim 33, comprising a symbol selector for selecting the symbols.

41. A game controller as claimed in claim 33, constituted, at least in part, by a processor executing program code stored in a memory.

42. A method of gaming comprising:
selecting at least one symbol of at least one reel of a plurality of reels to stop independently of the symbol sequence, each reel comprising a set of symbols in a symbol sequence, the selection being made independently of the symbol sequence;
causing a display to display each selected symbol at a display position; and
controlling display of spinning of the reels on the display such that for each reel for which at least one symbol is selected independently of the symbol sequence such that after at least one selected symbol is displayed as stopped at its display position, the remainder of the reel is displayed as spinning in the symbol sequence relative to the stopped symbol.

43. A method as claimed in claim 42, comprising selecting at least two symbols and to determine a stopping order for the at least two symbols.

44. A method as claimed in claim 42, comprising displaying a corresponding reel as continuing to spin in the symbol sequence until all of the at least one symbols have been displayed as stopping in their respective positions.

45. A method as claimed in claim 42, wherein a corresponding reel is displayed as spinning behind any stopped symbols such that the symbols of a corresponding reel are not visible as they pass each stopped symbol.

46. A computer readable medium comprising computer program code which when executed implements a method of gaming, said method comprising:
selecting at least one symbol of at least one reel of a plurality of reels to stop independently of the symbol sequence, each reel comprising a set of symbols in a symbol sequence, the selection being made independently of the symbol sequence;
causing a display to display each selected symbol at a display position; and
controlling display of spinning of the reels on the display such that for each reel for which at least one symbol is selected independently of the symbol sequence such that after at least one selected symbol is displayed as stopped at its display position, the remainder of the reel is displayed as spinning in the symbol sequence relative to the stopped symbol.

47. A computer readable medium comprising computer program code which when executed implements a method of gaming, said method comprising:
selecting symbols for each of a plurality of reels each for display at a plurality of display positions, each reel defined by a set of symbols in a symbol sequence, the selection of at least two symbols for at least one of a plurality of reels being made independently of the symbol sequence;
displaying the selected symbols at separate respective display positions on a display for each reel; and
controlling display of spinning of the reels on the display such that for each reel for which symbols are selected independently of the symbol sequence:
after the reel is stopped, the at least two selected symbols of each reel are displayed in their respective display positions; and
during at least part of the display of spinning, the reel is displayed as spinning in the symbol sequence relative to the display positions.
